(19) United States
(12) Patent Application Publication
(10) Pub. No.: US 2022/0063874 A1
(43) Pub. Date: Mar. 3, 2022

(54) PAPER AND PLASTIC COMBINED PACKAGING BOX

(71) Applicant: SHANGHAI ZIDAN FOOD PACKAGING & PRINTING CO., LTD, Shanghai (CN)

(72) Inventors: Weida LU, Shanghai (CN); Decang CHEN, Shanghai (CN); Jiadong WU, Shanghai (CN); Congyou HE, Shanghai (CN)

(21) Appl. No.: 17/418,781

(22) PCT Filed: Sep. 30, 2019
(86) PCT No.: PCT/CN2019/109480

§ 371 Date: Jun. 26, 2021

(30) Foreign Application Priority Data
Dec. 29, 2018 (CN) 201822254842.6

(51) Int. Cl. B65D 43/16; B65D 1/26

(52) U.S. Cl. CPC B65D 43/16; B65D 2543/00296; B65D 2543/00268; B65D 1/26

(57) ABSTRACT

The invention relates to a paper and plastic combined packaging box, which is flip-type packaging box, comprising a box cover cardboard, a box body cardboard portion and an integrated plastic frame formed by injection molding. The box body cardboard portion is formed as an enclosure by a plurality of cardboards, and has an upper edge. The integrated plastic frame formed by injection molding is configured to connect the box cover cardboard and the box body cardboard portion. The integrated plastic frame is comprised of a box body plastic member and a box cover plastic member which are connected through a plastic hinge. The box body plastic member is comprised of a main body of box body plastic member arranged at a gap between cardboards of the box body cardboard portion and an upper edge plastic member which is wrapped at the upper edge of the box body cardboard portion. The box cover plastic member is wrapped at the periphery of the box cover cardboard. The upper edge plastic member and the box cover plastic member are in a fastening connection to implement sealing of the packaging box. Compared with the prior art, the invention saves plastic, has high strength, high tightness and various shapes, and is low in cost.

### BACKGROUND OF THE INVENTION

### 1. Technical Field

The invention relates to a packaging box, in particular to a paper and plastic combined packaging box.

### 2. Description of Related Art

At present, the majority of packaging boxes for containing fluid or powder are metal or PE packaging boxes. As awareness of environmental protection grows, paper packaging boxes draw more and more attention. However, the paper packaging boxes face a problem of edge sealing, and their shape is greatly limited due to materials (most of the paper packaging boxes are square), which greatly limit the application of the paper packaging box.

### BRIEF SUMMARY OF THE INVENTION

The objective of the invention is to provide a paper and plastic combined packaging box to overcome defects in the prior art.

The objective of the invention can be achieved by the following technical solution:

A paper and plastic combined packaging box, which is a flip type packaging box, includes:

a box cover cardboard,

a box body cardboard portion, formed as an enclosure by a plurality of cardboards, and having an upper edge,

an integrated plastic frame molded by injection, configured to connect the box cover cardboard and the box body cardboard portion, where the integrated plastic frame is comprised of a box body plastic member and a box cover plastic member which are connected through a plastic hinge; the box body plastic member is comprised of a main body of box body plastic member arranged at a gap between cardboards of the box body cardboard portion and an upper edge plastic member which is wrapped at the upper edge of the box body cardboard portion; the box cover plastic member is wrapped on the periphery of the box cover cardboard; and the upper edge plastic member and the box cover plastic member are in a fastening connection to implement sealing of the packaging box.

Preferably, the box body cardboard portion is comprised of four side-walled cardboards for forming side walls and a box bottom cardboard for forming a box bottom, and the main body of box body plastic member is filled at the gap between the cardboards and wrapped on the inner side and outer side of the gap between cardboards.

Preferably, the width of the main body of box body plastic member wrapped on the inner side of the gap between the cardboards is greater than that on the inner side of the gap between the cardboards. The inner side of the packaging box is a face towards content, so a wider plastic member at the inner side of the gap between two adjacent cardboards can effectively avoid the content from wetting the cardboards, improving sealing performance.

Preferably, the cross section of the box body cardboard portion presents the shape of an elliptical rectangle. The elliptical rectangle is formed by slightly outward bending four sides on the basis of a rounded rectangle.

Preferably, the shape of the box cover cardboard is matched with that of the cross section of the box body cardboard portion .

Preferably, during sealing of the packaging box, the box cover plastic member is fastened on the upper edge plastic member and connected with the upper edge plastic member through a fastener.

Preferably, the main body of box body plastic member further includes a box bottom support rib.

Preferably, the integrated plastic frame formed by injection molding is made of an injectable molding material.

Preferably, the injectable molding material is a degradable material or a modified material which takes the degradable material as the mainstay.

Compared with the prior art, the invention has the following beneficial effects:

(1) On a tangent plane, the cardboard is wrapped by plastic, such that the cardboard is not moistened by fluid, and the packaging box is also sealed by the plastic member (fastening connection between the upper edge plastic member and the box cover plastic member), achieving high sealing performance.

(2) The integrated plastic frame, matched with cardboards made of different materials and exquisite printed patterns, can have various elegant appearances, overcoming the defect in the prior art that current cartons have a single shape.

(3) The paper and plastic combined packaging box, compared with cartons, has higher strength, greatly saves plastic while ensuring strength and sealing performance, not only reduces cost, but also is more environmentally-friendly.

### BRIEF DESCRIPTION OF THE SEVERAL VIEWS OF THE DRAWINGS

FIG. 1 is a schematic diagram of an open packaging box according to the invention;

FIG. 2 is a schematic diagram of a closed packaging box according to the invention;

FIG. 3 is a bottom view of a closed packaging box according to the invention.

Reference signs: 1. Box cover cardboard; 21. Side-walled cardboard; 22. Box bottom cardboard; 31. Main body of box body plastic member; 32. Upper edge plastic member; 33. Box bottom support rib; 4. Box cover plastic member. 5. Plastic hinge.

### DETAILED DESCRIPTION OF THE INVENTION

The invention is further described in detail in conjunction with the attached drawings and specific embodiment.

### Embodiment 1

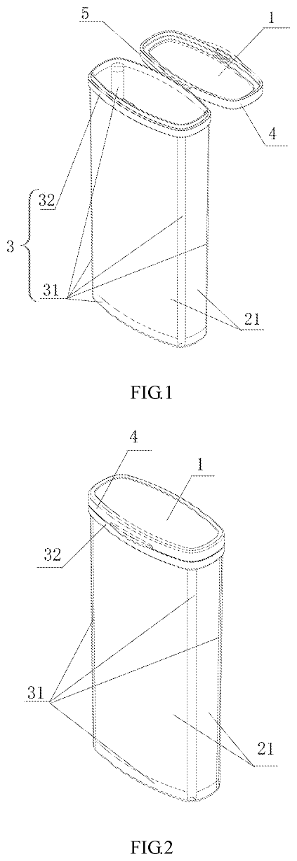

A paper and plastic combined packaging box, as shown in FIGS. 1 to 3, which is flip-type packaging box, includes a box cover cardboard 1, a box body cardboard portion and an integrated plastic frame formed by injection molding, where the box body cardboard portion is formed as an enclosure by a plurality of cardboards, and has an upper edge; the integrated plastic frame formed by injection molding is configured to connect the box cover cardboard 1 and the box body cardboard portion; the integrated plastic frame is comprised of a box body plastic member 3 and a box cover plastic member 4 which are connected through a plastic hinge 5; the box body plastic member 3 is comprised of a main body of box body plastic member 31 arranged at a gap between cardboards of the box body cardboard portion and an upper edge plastic member 32 which is wrapped at the upper edge of the box body cardboard portion; the box cover plastic member 4 is wrapped at the periphery of the box cover cardboard 1; and the upper edge plastic member 32 and the box cover plastic member 4 are in a fastening connection to implement sealing of the packaging box. According to this embodiment, during sealing of the packaging box, the box cover plastic member 4 is fastened on the upper edge plastic member 32 and connected with the upper edge plastic member through a fastener, as shown in FIG. 2.

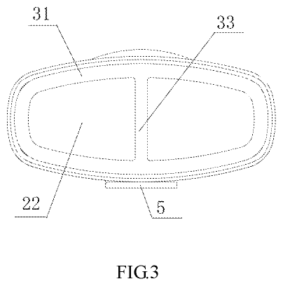

In the invention, the box body cardboard portion is preferably comprised of four side-walled cardboards 21 for forming side walls and a box bottom cardboard 22 for forming a box bottom, and the main body of box body plastic member 31 is filled at the gap between the cardboards and wrapped on the inner side and outer side of the gap between cardboards. To better avoid the tangent plane of the cardboard from wetting, the width of the main body of box body plastic member 31 wrapped on the inner side of the gap between the cardboards is greater than that on the inner side of the gap between the cardboards (as shown in FIG. 1). Preferably, the shape of the box cover cardboard 1 is matched with that of the cross section of the box body cardboard portion . In this embodiment, the cross section of the box body cardboard portion presents the shape of an elliptical rectangle. The elliptical rectangle is formed by slightly outward bending four sides on the basis of a rounded rectangle. Since the box bottom bears all weight of the content, the main body of box body plastic member of the invention further includes a box bottom support rib, which is arranged at the bottom of the box bottom cardboard 22 to enhance the strength of the box bottom, as shown in FIG. 3.

In this embodiment, plastic are formed by injection molding at the four corners and at the peripheries of the bottom, the edge and the cover, and the integrally molded hinge combines the box body and the box cover, such that a product has tightness after its cover is closed. Compared with existing products such as cartons, the paper and plastic combined packaging box has higher strength; since the cardboard on the tangent plane is wrapped by plastic, the cardboard is protected from wetting by liquid; and the packaging box, matched with cardboards made of different materials and exquisite printed patterns, has various elegant appearances.

### Embodiment 2

This embodiment is basically the same as embodiment 1. Further, in this embodiment, the integrated plastic frame formed by injection molding is made of every injectable molding material. Further preferably, in this embodiment, the injectable molding material is a degradable material or a modified material which takes the degradable material as the mainstay. Injectable molding materials mentioned in this embodiment include, but are not limited to PE, PP, PET, ABS, PLA, PBS, PHA, etc.

The description of the above embodiment is intended for helping those ordinarily skilled in this field to understand and use the invention. Those skilled in this field can obviously easily make various changes to the above embodiment, and apply the described general principle into other embodiment without creative labor. Therefore, the invention is not limited to the above embodiment. All improvements and changes made by those skilled in this field on the basis of the disclosure shall fall within the protective scope of the invention.

What is claimed is:

1. A paper and plastic combined packaging box, characterized in that the paper and plastic combined packaging box is a flip-type packaging box, comprising:
a box top cardboard (1),
a box body cardboard portion, formed as an enclosure by a plurality of cardboards, and having an upper edge,
an integrated plastic frame formed by injection molding, configured to connect the box cover cardboard (1) and the box body cardboard portion, wherein the integrated plastic frame is comprised of a box body plastic member (3) and a box cover plastic member (4) which are connected through a plastic hinge (5); the box body plastic member (3) is comprised of a main body of box body plastic member (31) arranged at a gap between cardboards of the box body cardboard portion and an upper edge plastic member (32) which is wrapped at the upper edge of the box body cardboard portion; the box cover plastic member (4) is wrapped at the periphery of the box cover cardboard (1); and the upper edge plastic member (32) and the box cover plastic member (4) are in a fastening connection to implement sealing of the packaging box.

2. The paper and plastic combined packaging box according to claim 1, wherein the box body cardboard portion is comprised of four side-walled cardboards (21) for forming side walls and a box bottom cardboard (22) for forming a box bottom, and the main board of box body plastic member (31) is filled at the gap between the cardboards and wrapped on the inner side and outer side of the gap between cardboards.

3. The paper and plastic combined packaging box according to claim 2, wherein the width of the main body of box body plastic member (31) wrapped on the inner side of the gap between the cardboards is greater than that on the inner side of the gap between the cardboards.

4. The paper and plastic combined packaging box according to claim 2, wherein the cross section of the box body cardboard portion presents the shape of an elliptical rectangle.

5. The paper and plastic combined packaging box according to claim 4, wherein the shape of the box cover cardboard (1) is matched with the shape of the cross section of the box body cardboard portion .

6. The paper and plastic combined packaging box according to claim 1, wherein during sealing of the packaging box, the box cover plastic member (4) is fastened on the upper edge plastic member (32) and connected with the upper edge plastic member through a fastener.

7. The paper and plastic combined packaging box according to claim 1, wherein the integrated plastic frame formed by injection molding is made of an injectable molding material.

8. The paper and plastic combined packaging box according to claim 7, wherein the injectable molding material is a degradable material or a modified material which takes the degradable material as the mainstay.
